(19) United States
(12) Patent Application Publication
(10) Pub. No.: US 2025/0284044 A1
(43) Pub. Date: Sep. 11, 2025

(54) OPTICAL FILTER AND METHOD OF PRODUCING OPTICAL FILTER

(71) Applicant: SEIKO EPSON CORPORATION, Tokyo (JP)

(72) Inventor: Kikuya MORITA, Shiojiri-shi (JP)

(21) Appl. No.: 19/070,570

(22) Filed: Mar. 5, 2025

(30) Foreign Application Priority Data
Mar. 5, 2024 (JP) 2024-033064

(51) Int. Cl. G02B 5/28

(52) U.S. Cl. CPC G02B 5/286

(57) ABSTRACT

An optical filter includes: a first substrate; a second substrate facing the first substrate via a gap; a first underlayer provided on a surface of the first substrate facing the second substrate; a second underlayer provided on a surface of the second substrate facing the first substrate; a first reflective film provided on the first substrate via the first underlayer and made of silver or a silver alloy; and a second reflective film provided on the second substrate via the second underlayer and made of silver or a silver alloy. The first underlayer and the second underlayer have a maximum height roughness of 7.3 nm or more.

The present application is based on, and claims priority from JP Application Serial Number 2024-033064, filed Mar. 5, 2024, the disclosure of which is hereby incorporated by reference herein in its entirety.

### BACKGROUND

### 1. Technical Field

The present disclosure relates to an optical filter and a method of producing an optical filter.

### 2. Related Art

In the related art, among optical filters having a substrate on which a reflective film is formed, there are known those that use a metal film such as silver or a silver alloy as the reflective film (see, for example, JP-A-2012-42584).

JP-A-2012-42584 discloses a configuration in which the metal film is formed at a glass substrate and the metal film is covered with a barrier layer to prevent a deterioration in the metal film. In addition, a configuration is disclosed in which a dielectric film is formed at a glass substrate, the metal film is formed at the dielectric film, and the dielectric film is covered with a protective layer.

However, when silver or the silver alloy is formed at the glass substrate, an aggregation of silver or the silver alloy may occur in a production step or due to an increase in temperature as of a use environment, and optical characteristics such transmittance and reflectance are deteriorated.

### SUMMARY

According to an aspect of the present disclosure, an optical filter includes: a first substrate; a second substrate facing the first substrate via a gap; a first underlayer provided on a surface of the first substrate facing the second substrate; a second underlayer provided on a surface of the second substrate facing the first substrate; a first reflective film provided on the first substrate via the first underlayer and made of silver or a silver alloy; and a second reflective film provided on the second substrate via the second underlayer and made of silver or a silver alloy. The first underlayer and the second underlayer have a maximum height roughness of 7.3 nm or more.

According to a second aspect of the present disclosure, provided is a method of producing an optical filter including a substrate, an underlayer provided on the substrate, and a reflective film made of silver or a silver alloy provided on the substrate via the underlayer. The method of producing an optical filter includes: an underlying step of forming the underlayer on the substrate by sputtering; and a reflective film step of forming the reflective film on the underlayer. In the underlying step, the underlayer is formed to have a maximum height roughness of 7.3 nm or more.

### BRIEF DESCRIPTION OF THE DRAWINGS

FIG. 1 is a cross-sectional view showing a schematic configuration of an interference filter according to an embodiment of the present disclosure.

FIG. 2 is a flowchart showing a method of producing the interference filter according to the present embodiment.

FIG. 3 is a diagram showing steps of a first substrate forming step.

FIG. 4 is a diagram showing steps of a second substrate forming step.

FIG. 5 is a diagram showing whether a silver alloy aggregates when a TiO₂ underlayer is formed at a wafer substrate by changing flow rates of an inert gas (Ar) and O₂, a silver alloy (Ag—Bi—Nd) film is formed at the underlayer, and then heated to 400° C.

FIG. 6 is a diagram showing a maximum surface height Rz of 2 μm square with respect to a film thickness of the underlayer.

FIG. 7 is a diagram showing a maximum surface height Rz of 5 μm square with respect to the film thickness of the underlayer.

FIG. 8 is a diagram showing transmittance of the interference filter according to the embodiment before heating and the transmittance after heating to 400° C.

FIG. 9 is a diagram showing transmittance of an interference filter according to a comparative example before heating and the transmittance after heating to 400° C.

FIG. 10 is a diagram showing an example of a binarized image obtained by heating the interference filter according to the embodiment to 400° C., capturing an image of a reflective film, and binarizing the captured image with a predetermined threshold value.

FIG. 11 is a schematic cross-sectional view of an interference filter according to a modification.

### DESCRIPTION OF EMBODIMENTS

Hereinafter, an interference filter as an optical filter according to an embodiment of the present disclosure will be described.

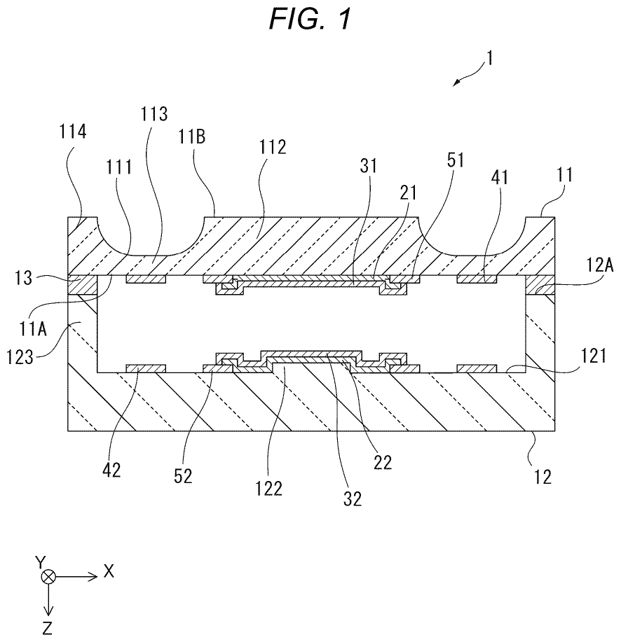

FIG. 1 is a cross-sectional view showing a schematic configuration of the interference filter according to the embodiment.

An interference filter 1 according to the embodiment is the optical filter according to the present disclosure, and the interference filter 1 includes a first substrate 11 and a second substrate 12 facing each other. A first underlayer 21 and a first reflective film 31 provided on the first substrate 11 via the first underlayer 21 are provided on a surface of the first substrate 11 facing the second substrate 12.

Similarly, a second underlayer 22 and a second reflective film 32 provided on the second substrate 12 via the second underlayer 22 are provided on a surface of the second substrate 12 facing the first substrate 11.

A first drive electrode 41 and a first detection electrode 51 are provided on the surface of the first substrate 11 facing the second substrate 12. A second drive electrode 42 facing the first drive electrode 41 and a second detection electrode 52 facing the first detection electrode 51 are provided on the surface of the second substrate 12 facing the first substrate 11.

In the following description, a direction from the first substrate 11 toward the second substrate 12 is referred to as a Z direction, a direction orthogonal to the Z direction is referred to as an X direction, and a direction orthogonal to the Z direction and the X direction is referred to as a Y direction. The Z direction corresponds to a thickness direction of the interference filter 1.

### Configuration of First Substrate 11

The first substrate 11 is formed by appropriately processing any one of quartz, non-alkali glass, and borosilicate glass into a desired shape.

Specifically, the first substrate 11 has a first surface 11A facing the second substrate 12 and a second surface 11B opposite to the first surface 11A. For example, an annular groove 111 is formed at the second surface 11B of the first substrate 11. In the first substrate 11, a portion surrounded by the groove 111 is referred to as a movable portion 112, a portion in which the groove 111 surrounding the movable portion 112 is formed is referred to as a diaphragm portion 113, and a portion outside the diaphragm portion 113 is referred to as an outer peripheral base portion 114. The diaphragm portion 113 couples the movable portion 112 and the outer peripheral base portion 114, and supports the movable portion 112 to be displaceable in the Z direction.

The outer peripheral base portion 114 of the first substrate 11 is bonded to the second substrate 12 by a bonding film 13.

### Configuration of First Underlayer 21

The first underlayer 21 is provided on the first surface 11A side of the movable portion 112.

In the embodiment, the first detection electrode 51 is formed in an annular shape surrounding the first reflective film 31, and the first underlayer 21 is formed at the first detection electrode 51 to overlap an inner peripheral side of the first detection electrode 51. In the example of FIG. 1, the first detection electrode 51 is formed at the first substrate 11, and the first underlayer 21 is formed thereon. A configuration may be used in which the first underlayer 21 is formed at the first substrate 11, and the first detection electrode 51 is formed thereon.

The first underlayer 21 is a layer formed of any one of TiO₂, Nb₂O₅, Ta₂O₅, HfO₂, ZrO₂, ITO, and IGO.

As will be described in detail later, the first underlayer 21 is formed to have a surface roughness (maximum height roughness Rz) of 7.3 nm or more, and more specifically, the maximum height roughness Rz is 7.3 nm or more in an area of 2 square micrometers, and the maximum height roughness Rz is 9.9 nm or more in an area of 5 square micrometers.

### Configuration of First Reflective Film 31

The first reflective film 31 is provided on the first underlayer 21 on the first surface 11A side of the movable portion 112. That is, the first reflective film 31 is provided on the first substrate 11 via the first underlayer 21.

The first reflective film 31 is a film made of, for example, silver or a silver alloy, and more preferably made of either Ag—Bi—Nd or Ag—Sm—Cu.

Although details will be described later, when the first reflective film 31 is formed at the first underlayer 21 having the maximum height roughness Rz of 7.3 nm or more, an aggregation of the first reflective film 31 is prevented even when the interference filter 1 is exposed to a high temperature, and a deterioration in optical characteristics (reflectance and transmittance) due to the aggregation is prevented.

### Configuration of First Drive Electrode 41

The first drive electrode 41 is provided in a substantially annular shape at a position of the diaphragm portion 113 on the first surface 11A of the first substrate 11. The first drive electrode 41 faces the second drive electrode 42 provided on the second substrate 12, and together with the second drive electrode 42 constitutes an electrostatic actuator. That is, by applying a predetermined drive voltage between the first drive electrode 41 and the second drive electrode 42, an electrostatic attraction force corresponding to the drive voltage acts between the first drive electrode 41 and the second drive electrode 42, causing the diaphragm portion 113 to bend and the movable portion 112 to be displaced along the Z direction.

### Configuration of First Detection Electrode 51

As described above, the first detection electrode 51 is formed in an annular shape along a periphery of the first reflective film 31 in the movable portion 112, and the first underlayer 21 is laminated on the surface facing the second substrate 12 on an inner peripheral side (center side of the movable portion 112).

Since the first reflective film 31 is formed to cover the first underlayer 21, an outer peripheral portion of the first reflective film 31 comes into contact with the first detection electrode 51 from a side surface of the first underlayer 21, and the first reflective film 31 and the first detection electrode 51 are electrically coupled to each other.

The first detection electrode 51 functions as a capacitance detection electrode together with the second detection electrode 52 provided on the second substrate 12. For example, a dimension between the first reflective film 31 and the second reflective film 32 can be calculated by detecting the static capacitance between the first reflective film 31 and the second reflective film 32 using the first detection electrode 51 electrically coupled to the first reflective film 31 and the second detection electrode 52 electrically coupled to the second reflective film 32.

The first detection electrode 51 may be used to release an electric charge of the first reflective film 31 by being coupled to the ground.

### Configuration of Second Substrate 12

Similarly to the first substrate 11, the second substrate 12 is formed by appropriately processing any one of quartz, non-alkali glass, and borosilicate glass into a desired shape.

Specifically, the second substrate 12 has a third surface 12A facing the first substrate 11, and the third surface 12A is provided with a recess 121 that is recessed on a side away from the first substrate 11 at a position facing the movable portion 112 and the diaphragm portion 113. In the embodiment, a protruding portion 122 protruding toward the first substrate 11 side is provided in a central portion of the recess 121, and a surface of the protruding portion 122 facing the first substrate 11 is a flat surface parallel to an XY plane. In the embodiment, an example in which the protruding portion 122 is provided is shown. When a wavelength range transmitted through the interference filter 1 is a near-infrared range or an infrared range, in order to increase the dimension between the first reflective film 31 and the second reflective film 32, a concave portion that is concave in the direction away from the first substrate 11 may be provided in the central portion of the recess 121 instead of the protruding portion 122.

A substrate bonding portion 123 bonded to the outer peripheral base portion 114 of the first substrate 11 is provided on an outer peripheral portion of the second substrate 12. A groove (not shown) communicating with the recess 121 is provided in a part of the substrate bonding portion 123, and extraction electrodes (not shown) of the first drive electrode 41, the second drive electrode 42, the first detection electrode 51, and the second detection electrode 52 are extracted to an outer peripheral edge of the second substrate 12 through the groove.

### Configuration of Second Underlayer 22

The second underlayer 22 is provided on the third surface 12A side of the second substrate 12.

In the embodiment, the second detection electrode 52 facing the first detection electrode 51 is formed in an annular shape surrounding the second reflective film 32, and the second underlayer 22 is formed at the second detection electrode 52 to overlap the inner peripheral side of the second detection electrode 52. In the example of FIG. 1, the second detection electrode 52 is formed at the second substrate 12, and the second underlayer 22 is formed thereon. A configuration may be used in which the second underlayer 22 is formed at the second substrate 12, and the second detection electrode 52 is formed thereon.

Similarly to the first underlayer 21, the second underlayer 22 is a layer formed of any one of TiO₂, Nb₂O₅, Ta₂O₅, HfO₂, ZrO₂, ITO, and IGO.

Similarly to the first underlayer 21, the second underlayer 22 is formed to have a surface roughness (maximum height roughness Rz) of 7.3 nm or more, and more specifically, the maximum height roughness Rz is 7.3 nm or more in an area of 2 square micrometers, and the maximum height roughness Rz is 9.9 nm or more in an area of 5 square micrometers.

### Configuration of Second Reflective Film 32

The second reflective film 32 is provided on the second underlayer 22 facing the first reflective film 31 and extending from a protruding tip surface of the protruding portion 122 of the second substrate 12 to a bottom surface of the recess 121. That is, the second reflective film 32 is provided on the second substrate 12 via the second underlayer 22.

The second reflective film 32 is a film made of, for example, silver or a silver alloy, and more preferably made of either Ag—Bi—Nd or Ag—Sm—Cu.

In the embodiment, when the second reflective film 32 is formed at the second underlayer 22 having the maximum height roughness Rz of 7.3 nm or more, an aggregation of the second reflective film 32 is prevented even when the interference filter 1 is exposed to a high temperature, and a deterioration in optical characteristics (reflectance and transmittance) due to the aggregation is prevented.

### Configuration of Second Drive Electrode 42

The second drive electrode 42 is provided in a substantially annular shape at a position facing the first drive electrode 41 on the third surface 12A of the second substrate 12. The Second drive electrode 42 constitutes the electrostatic actuator together with the first drive electrode 41.

### Configuration of Second Detection Electrode 52

As described above, the second detection electrode 52 is formed in an annular shape along the periphery of the second reflective film 32 in the recess 121, and the second underlayer 22 is laminated on the inner peripheral side.

Since the second reflective film 32 is formed to cover the second underlayer 22, an outer peripheral portion of the second reflective film 32 comes into contact with the second detection electrode 52 from a side surface of the second underlayer 22, and the second reflective film 32 and the second detection electrode 52 are electrically coupled to each other.

As described above, the second detection electrode 52 functions as the capacitance detection electrode together with the first detection electrode 51. The second detection electrode 52 may be used to release an electric charge of the second reflective film 32 by being coupled to the ground.

### Method of Producing Interference Filter 1

Next, a method of producing the interference filter 1 as described above will be described.

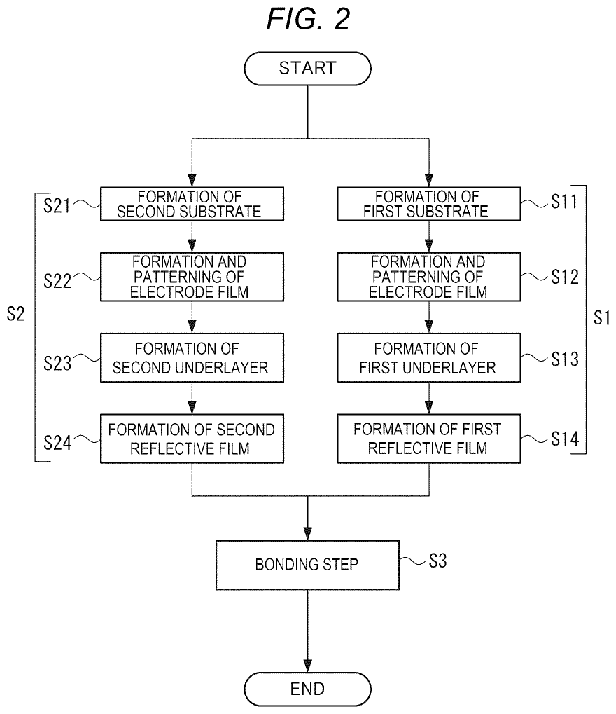

FIG. 2 is a flowchart showing a method of producing the interference filter 1.

As shown in FIG. 2, the interference filter 1 according to the embodiment is produced by performing a first substrate forming step S1, a second substrate forming step S2, and a bonding step S3. The order of the first substrate forming step S1 and the second substrate forming step S2 may be changed.

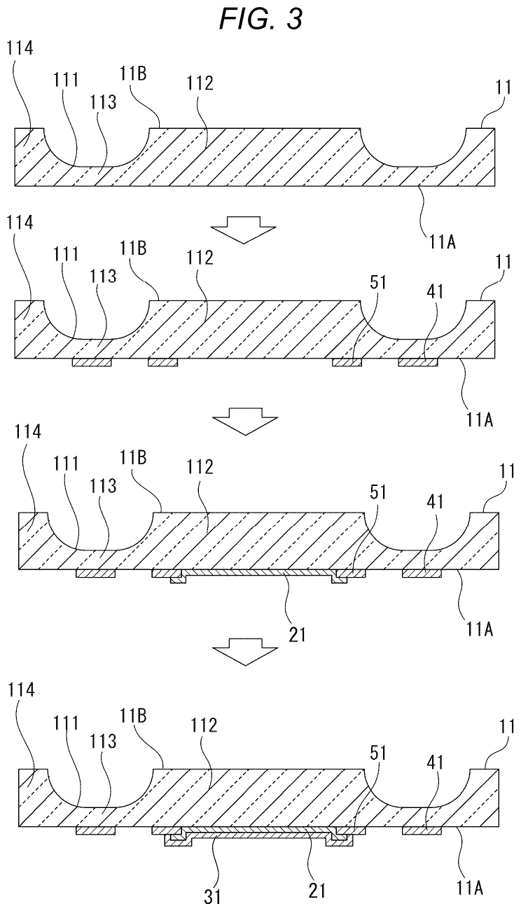

FIG. 3 is a diagram showing steps of the first substrate forming step S1.

In the first substrate forming step S1, first, a glass substrate serving as a base material of the first substrate 11 is ground to a desired thickness dimension, and the groove 111 is formed in the second surface 11B by etching. Accordingly, as shown in a first part of FIG. 3, the first substrate 11 including the movable portion 112, the diaphragm portion 113, and the outer peripheral base portion 114 is formed (step S11).

Next, an electrode film is formed at the first surface 11A of the first substrate 11, and is patterned using etching or the like (step S12). Accordingly, as shown in a second part of FIG. 3, the first drive electrode 41 and the first detection electrode 51 are formed.

Next, the first underlayer 21 is formed at the first surface 11A of the first substrate 11 (underlying step: step S13).

In the underlying step, the first underlayer 21 is formed at the first substrate 11 by sputtering. Specifically, the first substrate 11 and a forming material of the first underlayer 21 made of TiO₂ are placed in a vacuum chamber. Then, an inert gas such as an argon gas and O₂ are introduced into the vacuum chamber so that an amount of O₂ with respect to the inert gas is 1/9 or more, and a voltage is applied with the forming material (TiO₂) as a cathode and the first substrate 11 as an anode.

Accordingly, the first underlayer 21 is formed at the surface of the first substrate 11 by sputtering, and the surface roughness (maximum height roughness Rz) of the first underlayer 21 is 7.3 nm or more.

Thereafter, the first underlayer 21 is patterned by etching. Accordingly, as shown in a third part of FIG. 3, the first underlayer 21 is formed at the first substrate 11.

Thereafter, silver or a silver alloy as a forming material of the first reflective film 31 is formed at the first substrate 11 by, for example, sputtering, and patterning is performed by etching (reflective film step: step S14). Accordingly, as shown in a fourth part of FIG. 3, the first reflective film 31 is formed at the first substrate 11.

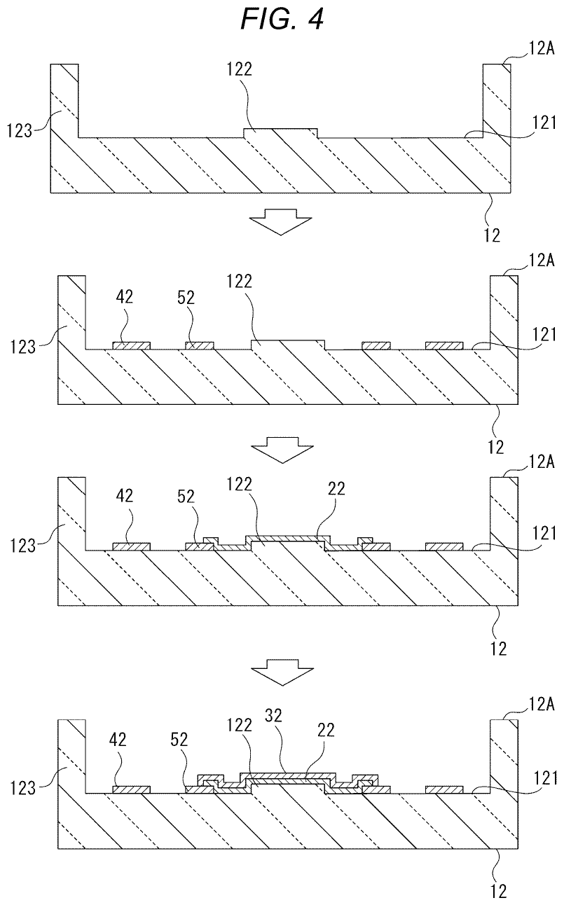

FIG. 4 is a diagram showing steps of the second substrate forming step S2.

In the second substrate forming step S2, first, a glass substrate serving as a base material of the second substrate 12 is ground to a desired thickness dimension, and the third surface 12A is subjected to two-stage etching, thereby forming the recess 121 and the protruding portion 122. Accordingly, an outer shape of the second substrate 12 is formed as shown in FIG. 4 (step S21).

Next, an electrode film is formed at the third surface 12A of the second substrate 12, and is patterned using etching or the like (step S22). Accordingly, as shown in a second part of FIG. 4, the second drive electrode 42 and the second detection electrode 52 are formed.

Next, the second underlayer 22 is formed at the third surface 12A of the second substrate 12 (underlying step: step S23).

In step S23, the second underlayer 22 is formed by the same method as in step S13.

That is, the second substrate 12 and a forming material of the second underlayer 22 made of TiO₂ are placed in a vacuum chamber. Then, an inert gas such as an argon gas and O₂ are introduced into the vacuum chamber so that an amount of O₂ with respect to the inert gas is 1/9 or more, and a voltage is applied with the forming material (TiO₂) as a cathode and the second substrate 12 as an anode.

Accordingly, the second underlayer 22 is formed at the surface of the second substrate 12 by sputtering, and the surface roughness (maximum height roughness Rz) of the second underlayer 22 is 7.3 nm or more.

Thereafter, the second underlayer 22 is patterned by etching. Accordingly, as shown in a third part of FIG. 4, the second underlayer 22 is formed at the second substrate 12.

Thereafter, silver or a silver alloy as a forming material of the second reflective film 32 is formed at the second substrate 12 by, for example, sputtering, and patterning is performed by etching (reflective film step: step S24). Accordingly, as shown in a fourth part of FIG. 4, the second reflective film 32 is formed at the second substrate 12.

Thereafter, the first substrate 11 formed by the first substrate forming step S1 and the second substrate 12 formed by the second substrate forming step S2 are bonded to each other via the bonding film 13. Accordingly, the interference filter 1 is produced.

### Optical Characteristics of First Reflective Film 31 and Second Reflective Film 32

Next, the optical characteristics of the first reflective film 31 and the second reflective film 32 of the interference filter 1 will be described.

In the interference filter 1 as described above, it is possible to maintain the optical characteristics of the first reflective film 31 and the second reflective film 32 even when the interference filter 1 is used in a use environment in which the temperature is increased or even when a heating step is included in a production step.

First, a difference in the surface roughness of the underlayer depending on an introduction amount of Oz in the underlying step (step S13, step S23) will be described.

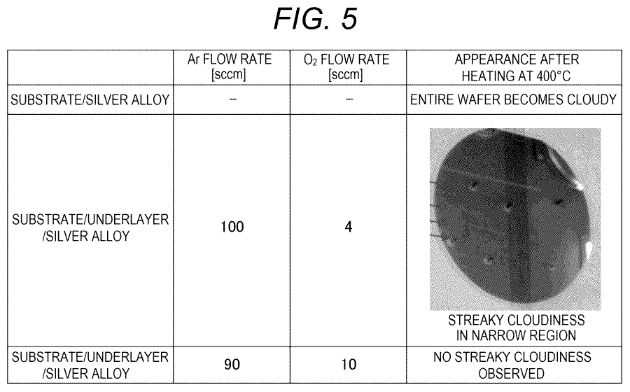

FIG. 5 is a diagram showing the presence or absence of an aggregation of a silver alloy when a underlayer of TiO₂ is formed at a wafer substrate by changing flow rates of an inert gas (Ar) and Oz, and a silver alloy (Ag—Bi—Nd) is formed at the underlayer and then heated to 400° C.

When the silver alloy is formed at the wafer substrate without forming the underlayer of TiO₂, cloudiness is observed over the entire silver alloy upon heating. This indicates that the aggregation of the silver alloy occurs in the entire wafer substrate.

When the underlayer of TiO₂ is formed at the wafer substrate by setting the flow rate of O₂ to 4 (sccm) and the flow rate of the inert gas (Ar) to 100 (sccm), a cloudy region is reduced compared to when O₂ is not introduced, but a slight streaky cloudy region is observed in a narrow range. In addition, “sccm” is a unit of flow rate, and indicates an introduction volume (cm³/min) per minute in an environment of an atmospheric pressure (1 atm=1013 hPa) and 0° C.

In contrast, when the flow rate of O₂ with respect to the flow rate of the inert gas is set to 1/9 or more, that is, when the underlayer is formed by the method shown in steps S13 and S23 of the method of producing the interference filter 1 in the embodiment, it is confirmed that the cloudy region on the wafer substrate is not observed and the aggregation of the silver alloy is prevented.

Next, the surface roughness of the underlayer in the case in which a TiO₂ film is formed by the underlying step (step S13, step S23) in the embodiment and the film thickness of the underlayer is changed will be described.

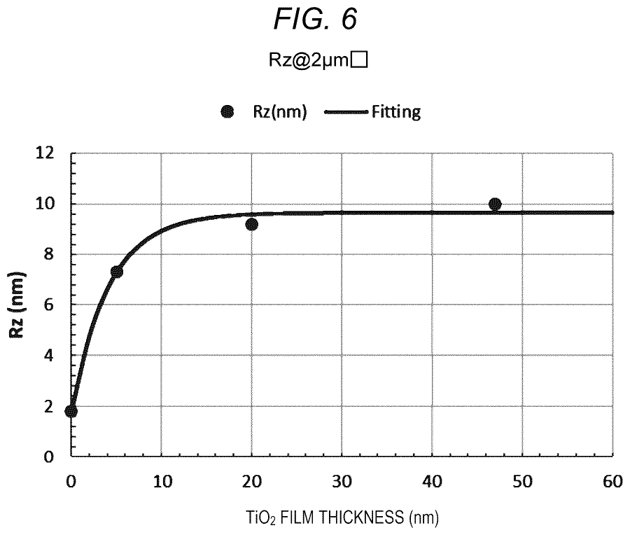

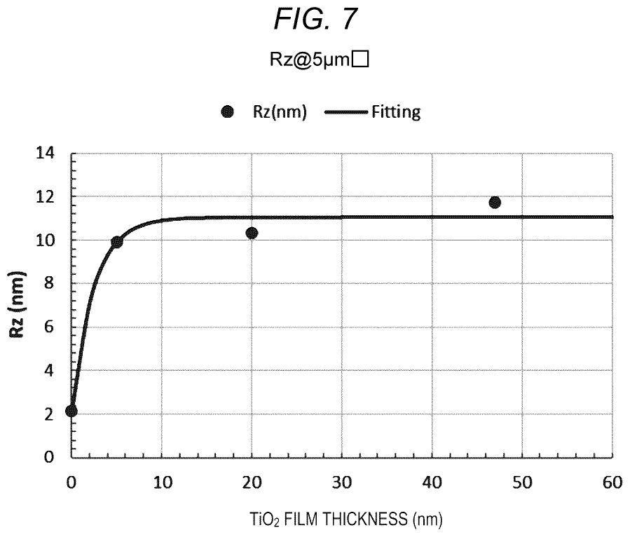

FIG. 6 is a diagram showing the maximum surface height Rz of 2 μm square with respect to the thickness of the underlayer, and FIG. 7 is a diagram showing the maximum surface height Rz of 5 μm square with respect to the thickness of the underlayer. Specifically, 2 μm square measurement (see FIG. 6) and 5 μm square measurement (see FIG. 7) are performed using an atomic force microscope (Park NX20 manufactured by Park System) in SPM mode.

As shown in FIGS. 6 and 7, when the thickness of the underlayer is 5 nm, the maximum surface height Rz at 2 μm square is 7.3 nm, and the maximum surface height Rz at 5 μm square is 9.9 nm. When the thickness of the underlayer is further increased, the maximum surface height Rz is saturated and approaches a constant value.

As described above, when the underlayers (the first underlayer 21 and the second underlayer 22) have the maximum surface height Rz of 7.3 nm or more in 2 μm square and the maximum surface height Rz of 9.9 nm or more in 5 μm square, a deterioration in the reflective film is prevented even under a heating environment. On the other hand, when the thickness of the underlayer is less than 5 nm, the surface roughness also decreases, and an effect of preventing the aggregation of the reflective film decreases.

Therefore, in the interference filter 1 according to the embodiment, the first underlayer 21 and the second underlayer 22 are formed to have a thickness of at least 5 nm or more, and the maximum height roughness Rz is 7.3 nm or more.

Next, the transmittance of the interference filter 1 according to the embodiment after heating will be described.

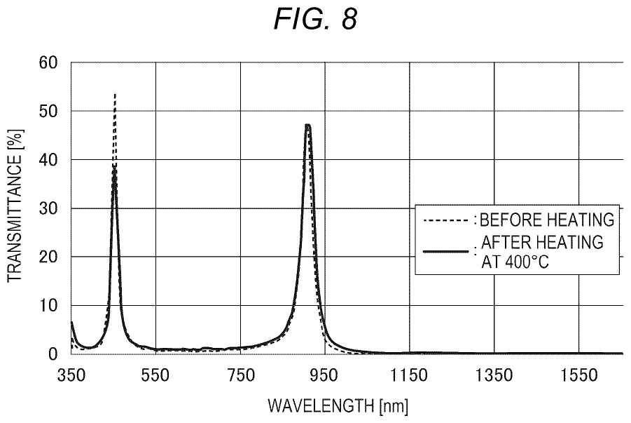

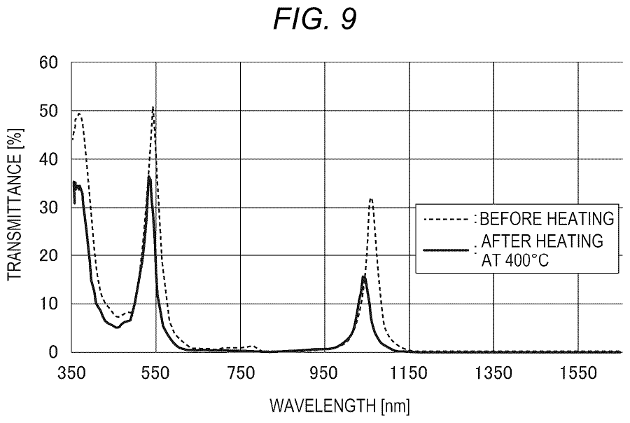

FIG. 8 is a diagram showing the transmittance of the interference filter 1 according to the embodiment before heating and after heating to 400° C. FIG. 9 is a diagram showing transmittance of an interference filter according to a comparative example before heating and after heating to 400° C.

Here, in the interference filter according to the comparative example, the first underlayer 21 and the second underlayer 22 of the interference filter 1 according to the embodiment are not provided, instead, the first reflective film 31 is formed at the first substrate 11, the first reflective film 31 is covered with a protective film formed of IGO, the second reflective film 32 is formed at the second substrate 12, and the second reflective film 32 is covered with a protective film formed of IGO.

As shown in FIG. 9, in the interference filter according to the comparative example, the transmittance after heating is reduced as a whole by about 15% as compared with the transmittance before heating. In this case, even if the aggregation of silver or the silver alloy constituting the reflective film is prevented by the protective film, the transmittance decreases by about 15%. In addition, by providing the protective film, a distance between adjacent peaks of the interference filter is reduced, and even when light of a desired wavelength is desired to be transmitted from the interference filter, transmitted light of the adjacent peak is mixed, and performance of the interference filter also decreases.

When the protective film is not formed in the interference filter, the reflective film becomes cloudy due to the aggregation of silver or the silver alloy depending on the use environment such as an increase in temperature, and the function as the interference filter is significantly reduced or does not function.

In contrast, in the embodiment, as shown in FIG. 8, a decrease in transmittance before and after heating is prevented for at least a wavelength range of 600 nm or more. That is, it can be seen that, when the distance between the first reflective film 31 and the second reflective film 32 is set such that light having an any peak wavelength of 600 nm or more is transmitted through the interference filter 1, the light transmittance at the peak wavelength before and after heating is reduced to less than 15%, and the optical characteristics of the interference filter 1 are maintained before and after heating. Further, in the embodiment, even when the protective film is not provided, the aggregation of silver or the silver alloy constituting the reflective film is prevented by the underlayer, and high optical characteristics can be maintained.

In the above example, the TiO₂ layer is used as the underlayer (the first underlayer 21 and the second underlayer 22), and similar effects can be confirmed with Nb₂O₅, Ta₂O₅, HfO₂, ZrO₂, ITO, and IGO.

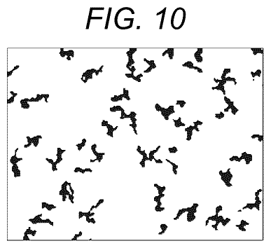

FIG. 10 is an example of a binarized image obtained by heating the interference filter 1 according to the embodiment to 400° C., capturing an image of the reflective films (the first reflective film 31 and the second reflective film 32), and binarizing the captured image with a predetermined threshold value. Specifically, FIG. 10 is an example of an image obtained by capturing an observation image of the reflective film by an optical microscope, detecting a pixel having the highest brightness and a pixel having the lowest brightness in the captured image, and binarizing the captured image using a brightness average value of these pixels as a threshold value. In FIG. 10, black portions are low-brightness pixels which are equal to or less than the threshold value, and white portions are pixels which are more than the threshold value.

When the thickness of the underlayer (the first underlayer 21 and the second underlayer 22) is set to 5 nm, when a binarized image as shown in FIG. 10 is generated with respect to a captured image of a plurality of portions of the reflective films (the first reflective film 31 and the second reflective film 32), an average area ratio of the low-brightness pixels having the brightness less than the threshold value is 10.93%. As described above, when the thickness of the underlayer is further increased, the value of the maximum surface height Rz is further increased, and the aggregation of silver or the silver alloy is further prevented, so that the average area ratio of the low-brightness pixels of the binarized image is further reduced to less than 10.93%.

As described above, in the interference filter 1 in which the reflective films (the first reflective film 31 and the second reflective film 32) made of silver or the silver alloy are formed at the substrates (the first substrate 11 and the second substrate 12) via the underlayers (the first underlayer 21 and the second underlayer 22) having the maximum surface height Rz of 7.3 nm or more, the aggregation of silver or the silver alloy in the reflective film is prevented even in a heating environment, and the average area ratio of the binarized image is 10.93% or less. Accordingly, it is possible to provide the interference filter 1 in which a decrease in transmittance is reduced to less than 15% for a wavelength region of at least 600 nm or more and high optical characteristics are maintained even after heating.

### Effects of Embodiment

An interference filter 1 according to the embodiment includes a first substrate 11, a second substrate 12 facing the first substrate 11 via a gap, a first underlayer 21 provided on a first surface 11A of the first substrate 11, a second underlayer 22 provided on a third surface 12A of the second substrate 12, a first reflective film 31 provided on the first substrate 11 via the first underlayer 21 and made of silver or a silver alloy, and a second reflective film 32 provided on the second substrate 12 via the second underlayer 22 and made of silver or a silver alloy. Further, the first underlayer 21 and the second underlayer 22 are formed to have a maximum height roughness Rz of 7.3 nm or more.

In such an interference filter 1, even when the interference filter 1 is exposed to a high temperature, for example, of 400° C. or higher, when used in a high temperature environment or when heated during production, an aggregation of silver or the silver alloy constituting the reflective films (the first reflective film 31 and the second reflective film 32) is prevented by the underlayers (the first underlayer 21 and the second underlayer 22), and high optical characteristics can be maintained.

In addition, as compared with the case in which another protective film is provided, the optical characteristics (transmittance and reflectance) are improved, and even in a high temperature environment, a deterioration in the optical characteristics is prevented. Further, as compared with the case in which another protective film is provided, it is possible to expand an interval between peak wavelengths of light transmitted through the interference filter 1, and it is also possible to prevent inconvenience of light of adjacent peak wavelengths being mixed together.

In the interference filter 1 according to the embodiment, an area ratio of a low brightness region of a binarized image of a captured image obtained by capturing the reflective films (the first reflective film 31 and the second reflective film 32) is less than 10.93%.

Accordingly, the optical characteristics of the interference filter 1 are improved, and the deterioration in the optical characteristics can be prevented even when the temperature is increased.

In the interference filter 1 according to the embodiment, when a distance between the first reflective film 31 and the second reflective film 32 is set such that any peak wavelength in a wavelength range of 600 nm or more is transmitted by multiple reflection by the first reflective film 31 and the second reflective film 32, a change amount of the transmittance of light of the peak wavelength before and after heating is less than 15%.

Therefore, even when the interference filter 1 is exposed to a high temperature environment, high optical characteristics can be maintained.

In the interference filter 1 according to the embodiment, the first substrate 11 and the second substrate 12 are any of quartz, non-alkali glass, and borosilicate glass.

By using quartz, non-alkali glass, or borosilicate glass for the first substrate 11 or the second substrate 12, it is possible to provide the interference filter 1 having a visible light region as a spectral target wavelength region.

In the interference filter 1 according to the embodiment, the first underlayer 21 and the second underlayer 22 are any of TiO₂, Nb₂O₅, Ta₂O₅, HfO₂, ZrO₂, ITO, and IGO.

By using such a material, it is possible to form the first underlayer 21 and the second underlayer 22 having the maximum height roughness Rz of 7.3 nm more easily by sputtering without performing another step such as a surface treatment.

In the interference filter 1 according to the embodiment, the first reflective film 31 and the second reflective film 32 are made of a silver alloy and are either Ag—Bi—Nd or Ag—Sm—Cu.

When silver is used for the first reflective film 31 and the second reflective film 32, a deterioration due to oxidation or the like is likely to occur. In contrast, when either Ag—Bi—Nd or Ag—Sm—Cu is used, the deterioration in the reflective film can be prevented.

The interference filter 1 according to the embodiment includes an underlying step (steps S13 and S23) of forming an underlayer on a substrate by sputtering, and a reflective film step (steps S14 and S24) of forming a reflective film on the underlayer, and in the underlying step, the underlayer is formed to have the maximum height roughness Rz of 7.3 nm or more.

Accordingly, even when the filter is exposed to a high temperature, such as 400° C. or higher, during use in a high temperature environment or during heating during production as described above, the aggregation of silver or the silver alloy constituting the reflective film is prevented, making it possible to produce the interference filter 1 maintaining high optical characteristics.

In the embodiment, in the underlying step, TiO₂ used as the underlayer and the substrate are installed in a chamber in a vacuum state, an inert gas and O₂ are introduced into the chamber so that an amount of O₂ with respect to the inert gas is 1/9 or more, and a voltage is applied using TiO₂ as a cathode and the substrate as an anode, thereby forming a film on the substrate using TiO₂ as the underlayer.

Accordingly, an underlayer having a maximum height roughness Rz of 7.3 nm or more can be easily formed by sputtering, and a surface treatment such as sand blasting can be eliminated.

### Modifications

The present disclosure is not limited to the above embodiment, and modifications, improvements, or the like within a scope that can achieve the object of the present disclosure are in the present disclosure.

For example, in the first embodiment, the first underlayer 21 is provided only on a part of the first substrate 11, and the second underlayer 22 is provided only on a part of the second substrate 12. However, the present disclosure is not limited to the above configuration.

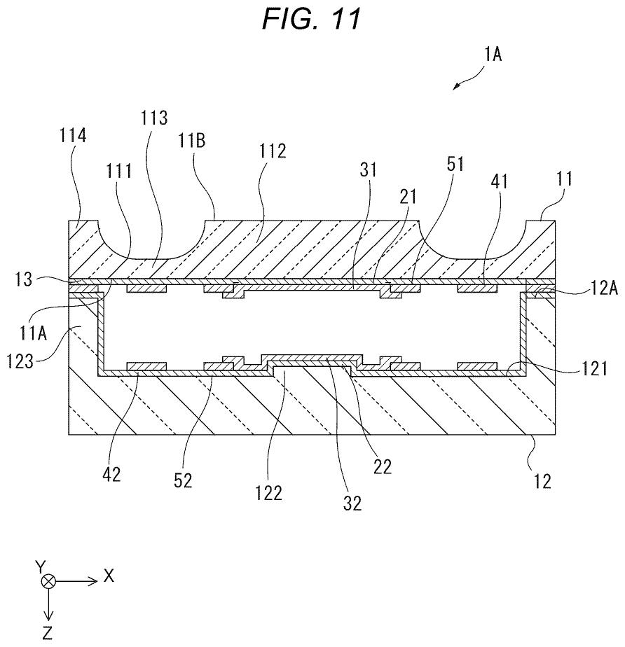

FIG. 11 is a schematic cross-sectional view of an interference filter 1A according to a modification.

For example, as shown in FIG. 11, the first underlayer 21 may be formed at the entire first surface 11A of the first substrate 11, and the second underlayer 22 may be formed at the entire third surface 12A of the second substrate 12.

In this case, the step of patterning the first underlayer 21 and the second underlayer 22 by etching or the like can be omitted.

### SUMMARY OF PRESENT DISCLOSURE

According to an aspect of the present disclosure, an optical filter includes: a first substrate; a second substrate facing the first substrate via a gap; a first underlayer provided on a surface of the first substrate facing the second substrate; a second underlayer provided on a surface of the second substrate facing the first substrate; a first reflective film provided on the first substrate via the first underlayer and made of silver or a silver alloy; and a second reflective film provided on the second substrate via the second underlayer and made of silver or a silver alloy. The first underlayer and the second underlayer have a maximum height roughness of 7.3 nm or more.

In such an optical filter, even when exposed to a high temperature of, for example, 400° C. or higher during use in a high temperature environment or heating during production, an aggregation of silver or the silver alloy constituting the reflective film (the first reflective film and the second reflective film) is prevented by the underlayers (the first underlayer and the second underlayer), and high optical characteristics can be maintained. In addition, by forming the reflective film on the underlayer, the optical characteristics (transmittance and reflectance) are improved.

In the optical filter according to the aspect, in a captured image obtained by capturing an image of the first reflective film and the second reflective film, an intermediate brightness which is an average brightness between a pixel having a lowest brightness and a pixel having a highest brightness is set as a threshold value, and an area ratio of a low brightness region having a low brightness when the captured image is binarized using the threshold value is less than 10.93%.

Accordingly, the optical characteristics of the optical filter are improved, and a deterioration in the optical characteristics can be prevented even when the temperature is increased.

In the optical filter according to the aspect, when a distance between the first reflective film and the second reflective film is set such that any peak wavelength in a wavelength range of 600 nm or more is transmitted by multiple reflection by the first reflective film and the second reflective film, a change amount of transmittance of light having the peak wavelength due to heating of the first reflective film and the second reflective film is less than 15%.

Accordingly, even when the optical filter is exposed to a high temperature environment, high optical characteristics can be maintained.

In the optical filter according to the aspect, the first substrate and the second substrate are any of quartz, non-alkali glass, and borosilicate glass.

Accordingly, it is possible to provide an optical filter in which a visible light region is set as a spectral target wavelength region.

In the optical filter according to the aspect, the first underlayer and the second underlayer are any one of TiO₂, Nb₂O₅, Ta₂O₅, HfO₂, ZrO₂, ITO, and IGO.

By using such a material, it is possible to form the first underlayer and the second underlayer having the maximum height roughness Rz of 7.3 nm more easily by sputtering without performing another step such as a surface treatment.

In the optical filter according to the aspect, the first reflective film and the second reflective film are made of a silver alloy and are either Ag—Bi—Nd or Ag—Sm—Cu.

Accordingly, a deterioration due to oxidation or the like of the first reflective film or the second reflective film can be prevented.

According to a second aspect of the present disclosure, provided is a method of producing an optical filter including a substrate, an underlayer provided on the substrate, and a reflective film made of silver or a silver alloy provided on the substrate via the underlayer. The method comprising: an underlying step of forming the underlayer on the substrate by sputtering; and a reflective film step of forming the reflective film on the underlayer. In the underlying step, the underlayer is formed to have a maximum height roughness of 7.3 nm or more.

Accordingly, it is possible to produce the optical filter according to the first aspect described above, even when the filter is exposed to a high temperature, for example, 400° C. or higher, during use in a high temperature environment or during heating during production, the aggregation of silver or the silver alloy constituting the reflective film is prevented, making it possible to produce the optical filter maintaining high optical characteristics.

In the method of producing an optical filter according to the aspect, in the underlying step, TiO₂ used as the underlayer and the substrate are installed in a chamber in a vacuum state, an inert gas and O₂ are introduced into the chamber so that an amount of O₂ with respect to the inert gas is 1/9 or more, and a voltage is applied using TiO₂ as a cathode and the substrate as an anode, thereby forming a film on the substrate using TiO₂ as the underlayer.

Accordingly, an underlayer having a maximum height roughness Rz of 7.3 nm or more can be easily formed by sputtering, and a surface treatment such as sand blasting can be eliminated.

What is claimed is:

1. An optical filter comprising:
a first substrate;
a second substrate facing the first substrate via a gap;
a first underlayer provided on a surface of the first substrate facing the second substrate;
a second underlayer provided on a surface of the second substrate facing the first substrate;
a first reflective film provided on the first substrate via the first underlayer and made of silver or a silver alloy; and
a second reflective film provided on the second substrate via the second underlayer and made of silver or a silver alloy, wherein
the first underlayer and the second underlayer have a maximum height roughness of 7.3 nm or more.

2. The optical filter according to claim 1, wherein
in a captured image obtained by capturing an image of the first reflective film and the second reflective film, an intermediate brightness which is an average brightness between a pixel having a lowest brightness and a pixel having a highest brightness is set as a threshold value, and an area ratio of a low brightness region having a low brightness when the captured image is binarized using the threshold value is less than 10.93%.

3. The optical filter according to claim 1, wherein
when a distance between the first reflective film and the second reflective film is set such that any peak wavelength in a wavelength range of 600 nm or more is transmitted by multiple reflection by the first reflective film and the second reflective film, a change amount of transmittance of light having the peak wavelength due to heating of the first reflective film and the second reflective film is less than 15%.

4. The optical filter according to claim 1, wherein
the first substrate and the second substrate are any of quartz, non-alkali glass, and borosilicate glass.

5. The optical filter according to claim 1, wherein
the first underlayer and the second underlayer are any one of TiO₂, Nb₂O₅, Ta₂O₅, HfO₂, ZrO₂, ITO, and IGO.

6. The optical filter according to claim 1, wherein
the first reflective film and the second reflective film are made of a silver alloy and are either Ag—Bi—Nd or Ag—Sm—Cu.

7. A method of producing an optical filter including a substrate, an underlayer provided on the substrate, and a reflective film made of silver or a silver alloy provided on the substrate via the underlayer, the method comprising:
an underlying step of forming the underlayer on the substrate by sputtering; and
a reflective film step of forming the reflective film on the underlayer, wherein
in the underlying step, the underlayer is formed to have a maximum height roughness of 7.3 nm or more.

8. The method of producing an optical filter according to claim 7, wherein
in the underlying step, TiO₂ used as the underlayer and the substrate are installed in a chamber in a vacuum state, an inert gas and Oz are introduced into the chamber so that an amount of Oz with respect to the inert gas is 1/9 or more, and a voltage is applied using TiO₂ as a cathode and the substrate as an anode, thereby forming a film on the substrate using TiO₂ as the underlayer.
